(19) United States
(12) Patent Application Publication
(10) Pub. No.: US 2013/0054351 A1
(43) Pub. Date: Feb. 28, 2013

(54) USER-CURATED BUSINESS RECOMMENDATIONS

(71) Applicants: Peter Krugman, Ridgewood, NJ (US); Peter Tafeen, Parkland, FL (US); Michael J. Rotondi, New York, NY (US)

(72) Inventors: Peter Krugman, Ridgewood, NJ (US); Peter Tafeen, Parkland, FL (US); Michael J. Rotondi, New York, NY (US)

(21) Appl. No.: 13/560,745

(22) Filed: Jul. 27, 2012

Related U.S. Application Data
(60) Provisional application No. 61/513,512, filed on Jul. 29, 2011.

(51) Int. Cl. G06Q 30/02

(52) U.S. Cl. 705/14.44; 705/14.58

(57) ABSTRACT

Methods and systems for providing promotional information include collecting information at a server regarding promotions, including promotion location, supplied by a plurality of individual users. A request is received at the server from a requesting user that includes a user location. The server searches the promotional information to generate a list of promotions within a radius of the user location. The server then transmits the list of promotions to the requesting user.

### RELATED APPLICATION INFORMATION

This application claims priority to provisional application Ser. No. 61/513,512, filed on Jul. 29, 2011, incorporated herein by reference.

### BACKGROUND

1. Technical Field

The present invention relates to location-based mobile services and, more particularly, to providing offers and discounts to users based on geographical location.

2. Description of the Related Art

With the increasing ubiquity of mobile technology, users find themselves increasingly capable of locating vendors and services in unfamiliar areas. For example, a user is able to call up a map and display the locations of, for example, nearby restaurants. However, while users are often able to leave reviews and recommendations regarding particular establishments, businesses have no way to differentiate themselves from the rest of the pack.

Traditionally, businesses advertised in physical media to inform people of their services and attract business. For example, a business might create paper flyers or circulars that displayed the business's services and advertised discounts and sales. Simply purchasing online advertisements cannot replicate this function, because it does not provide the sort of immediate information to consumers that would make such discounts and sales relevant.

### SUMMARY

A method for providing promotional information includes collecting information at a server regarding promotions, including promotion location, supplied by a plurality of individual users; receiving a request at the server from a requesting user that includes a user location; searching the information at the server using a processor to generate a list of promotions within a radius of the user location; and transmitting the list of promotions to the requesting user.

A system for providing promotional information includes a server configured to collect information regarding promotions supplied by a plurality of individual users, where said information includes a promotion location, and to receive a request from a requesting user that includes a user location. The server includes a database configured to store the collected information; a processor configured to search the database to generate a list of promotions within a radius of the user location; and a communication module configured to transmit the list to of promotions to the requesting user.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a system for providing promotional information according to the present principles.

FIG. 2 is a block/flow diagram of a method for rewarding users and businesses for participating in the promotional system according to the present principles.

FIG. 3 is a diagram of an exemplary interface design for presenting promotional information according to the present principles.

FIG. 4 is a block/flow diagram of a method for crowdsourcing promotional information according to the present principles.

FIG. 5 is a block/flow diagram of a method for rewarding users for participating in the promotional system according to the present principles.

FIG. 6 is a diagram of a server for collecting and distributing promotional information according to the present principles.

### DETAILED DESCRIPTION OF PREFERRED EMBODIMENTS

The present principles provide the ability for businesses to provide users with information regarding nearby deals and discounts. Users are given the ability to search for deals in the nearby area using, e.g., a map function.

In one embodiment present principles are embodied as a mobile software application on a mobile device connected to the Internet. The mobile device may be, e.g., a smartphone, tablet, iPhone® mobile device, iPad® mobile device, etc., that uses GPS technology or a user's input location to find local businesses and activities that are currently offering deals to customers. The mobile software application can display a street map of the user's current location with icons on local addresses. The user can tap a location's icon, e.g., a “fork” image, to cause the mobile software application to display a description of an active restaurant deal at the specified location. Similarly, the user can tap a location on the map that displays a “store” icon, for example, causing the mobile software application to display a description of an active retail or vendor deal at the specified location. It should be recognized that these examples are provided for illustration only and should not be considered to be limiting as to the types and varieties of businesses or services which may be displayed.

One advantage of this embodiment of the invention is that the mobile software application can deliver a real-time, targeted version of the traditional paper flyer, printed coupon book, or other printed collections of offers for discounts. This allows local merchants the ability to serve targeted ads to local consumers who a) have already expressed an interest in the type of offer and b) are within walking distance of the merchant. The offers can change as the user walks or drives around town based on location or other criteria.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc. or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

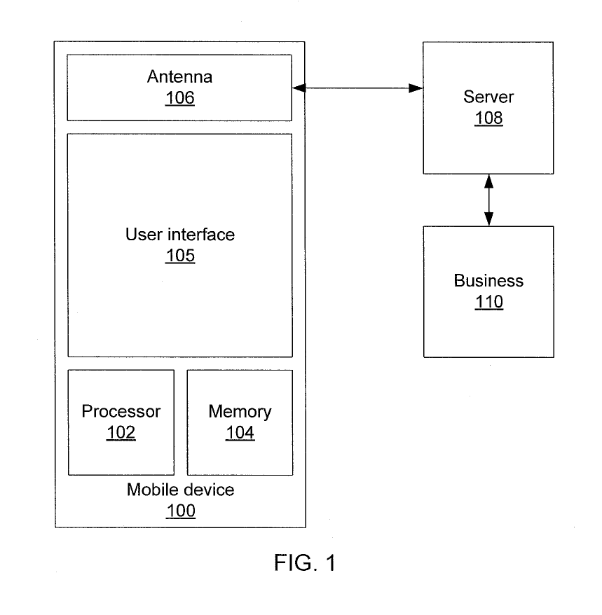

Referring now to the drawings in which like numerals represent the same or similar elements and initially to FIG. 1, a system for providing local deals to a mobile user device 100 is shown. The mobile user device 100 includes a processor 102 and memory 104 in communication with a user interface 105. The user interface 105 includes some form of display, e.g., graphical or text-based, some form of user input, e.g., a keyboard, keypad, or touch-screen, and some form of alert mechanism, e.g., audio or vibration. The user interface 105 allows a user to input a request for a search for local deals, where said request is processed by the processor 102 and communicated via antenna 106 to a server 108. The request to the server 108 includes a user location, whether acquired from a global positioning system (GPS) receiver (not shown) or entered with user interface 105. The request may further include a specific type of vendor/service that is desired.

Businesses 110, meanwhile, have provided information to server 108. This info nation may include identifying information, such as location, business hours, contact information, etc., and further includes information regarding deals and promotions, along with a time frame associated with such deals and promotions. The server 108 determines a set of information most responsive to the user's request based on the location of mobile device 100. The response is sent back to the mobile device 100.

The mobile device 100 stores the response in memory 104 and displays it using user interface 105. This allows the user to determine what promotions are close by and to request additional information. The user interface 105 may furthermore provide a graphical view of the local area, so that the user can determine how to locate the business, and the user interface 105 may further provide detailed driving or walking instructions to get to said business.

The request may further be left in a “live” state. This may entail storing the request at the memory 104 of mobile device 100 and sending periodic requests to the server 108, or it may entail storing the request at the server 108 and merely sending periodic location updates. This may be performed as a background process, where the mobile device 100 alerts the user when the user is within a predefined distance from a venue that the system determines may be of interest. This determination may be based on prior choices and preset filter settings. The system can use GPS or other location determining methods to judge the speed of travel and give appropriate notice whether the user, e.g., is walking, biking, or driving.

A database at server 108 can be pre-populated with the names and addresses of businesses 110, including merchants, service providers, and venues in one or more of the following exemplary categories: banks/ATMs, coffee shops, grocery stores, personal services, bars, concert/music venues, hotels and & lodging, public transit, beaches & pools, fast food, movie theaters, restaurants, children's events, gas/auto repair, parking, and shops/retailers. These pre-populated database entries may include venues with free items and services. The display of free activities and venues on the mobile software application has the benefit of encouraging a more widespread use of and familiarity with the mobile software application. The more the application is used, the greater the value will be to venue owners to ensure that their promotions are included.

Businesses 110 can subsequently be added to the database at server 108 by users and ranked by other users through features in the mobile software application. These additional entries in the database at server 108 can also include venues with free items and services. Populating the database with businesses 110 discovered by and ranked by the users of the mobile software application creates allows community-based control of the visibility of locations within the system. All displayed businesses 110 can thus be crowd-sourced and actively curated by the users.

Optionally, when users initially register to use the mobile software application, they may securely register one or more credit cards. When businesses 110 sign up with system they may authorize the system to access their sales data feeds. Optionally the transaction could be monitored by the use of a chip in the device 100 that communicates with a device at the business 110, for example, by way of a Near Field Communication (NFC) system. This combination enables the system to track users' unique buying habits down to specific purchases at specific places and times, and allows merchants extremely specific direct sales tracking that they can utilize to great benefit for sales, personnel, and inventory planning.

The system can award points for discovering and/or visiting locations. For example, when a user comes upon a business 110 that is giving away something, the user can easily add the location to the database at server 108 using mobile device 100 and earn points. When a user adds a location, both the user and the business 110 earn a point value. Subsequent visitors to the location can also earn points as does both the location and the original discoverer. This motivates users to seek out and introduce new businesses 110 into the system.

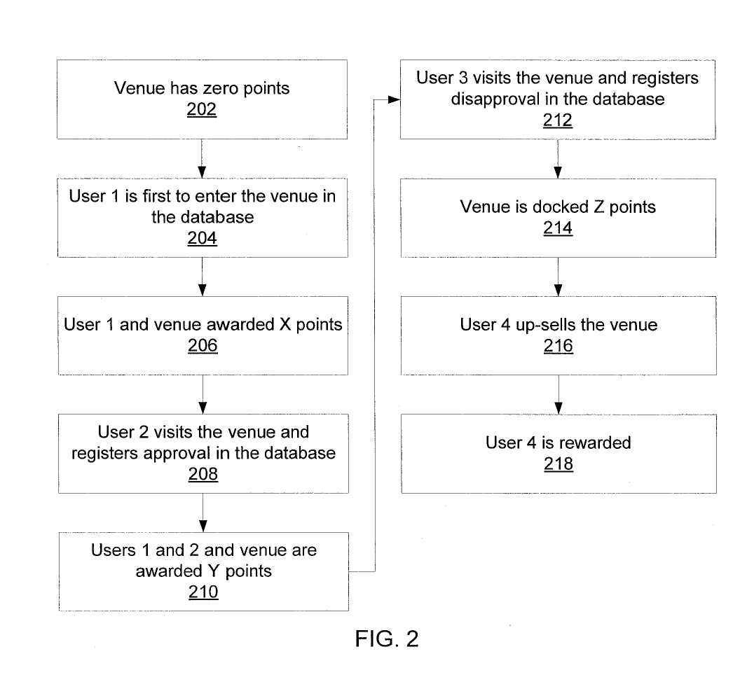

Referring now to FIG. 2, a method for awarding points to users and to venues is shown. In block 202, the business 110 has zero points. A first user enters the venue into a database at server 108 at block 204. The database entry may include the venue name, business type, location, contact information, promotions available at the venue, etc., and may be entered from the mobile device 100 or from any other Internet-capable terminal. Upon registration of the business 110, both the business 110 and the first user are awarded X points. The specific number of points may be determined according to the needs of the particular system and may differ for the user and the venue. Furthermore, the point values may be assigned dynamically based on, e.g., special promotions or statuses within the system. For example, an experienced user who has registered many new businesses may be awarded a higher number of points.

At block 208, a second user visits the venue and has a positive experience. The user registers approval in the database at server 108 using, e.g., the mobile device 100. Block 210 then awards Y points to the discoverer, user 1, to the reviewer, user 2, and to the business 110. At block 212, however, a third user visits the venue and has a negative experience—for example, the user finds that a promotion is not being honored. The third user registers disapproval in the database at server 108. At block 214, responsive to the disapproval, the venue is docked Z points. The server 108 maintains a running point total for all users and businesses 110.

To provide an incentive to users, the points system is linked to levels/achievements that the users can earn. As a user increases in level and accumulate achievements, different options and benefits may be made available to the user. For example, some deals may be made specific to high-level users. This motivates users to continue to explore and register new businesses 110 and to register their approvals and disapprovals of already-registered businesses 110.

An additional incentive to users may be included as an automatic rebate. For example, when a user shops at a given sponsored business 110 using the mobile software application, the user may receive a rebate. A portion of the fee paid by sponsored vendors at each sale with the application is sent directly to the user. The user may elect to have this rebate redirected to another party, group, or organization. For example, the user may choose to have rebates sent to a charity of choice.

One benefit of this system is that the users continuously validate the businesses 110. The prominence with which each business 110 is displayed in user interface 105 can be increased based on the point total accumulated by that business 110. Thus, the best offers will always be the most prominent because the users have an incentive to discover, sign up, and rate businesses 110. Those businesses 110 that do not generate approval votes will lose prominence or disappear from the system over time. Similarly, locations that receive disapproval votes will lose prominence or disappear from the system over time.

Businesses may also have the opportunity to sponsor paid locations that can be clearly marked as advertisements. These locations would have a web/mobile mechanism that allows the merchant to change its current discount dynamically to reflect overstocked and sold out items. Voting for sponsored locations could optionally be disabled. At block 216, a fourth user may “up-sell” the business 110 by signing a non-sponsored business 110 up to be a sponsored location. The user solicits the owner or manager of the business 110 and as an incentive, block 218 rewards the fourth user.

As an incentive to solicit sponsored locations, if the business subsequently opts to establish a sponsored location, the user who made the solicitation can receive an award, such as a percentage of every subsequent transaction that users complete at that location in the future. Optionally, the amount of time for which the users receives an award can expire, for example, after two years. Preferably, but optionally, the sponsorship would not impose a monthly cost to the business 110, and instead the system operator could receive a small commission or percentage of verifiable sales brought in through the mobile software application. Like the award points described above, this percentage could be divided between the system operator and the initial user that solicited the location. Optionally, the subsequent users who complete a transaction could also receive a portion of the sales, in effect getting a rebate on the purchase.

The system's underlying relational database collects and catalogues similar users' check-ins/purchases, which will allow the system to predict where, when, and what a user will want to do at a given time and location, and make recommendations. The system's ability to drive traffic using the accumulated data provides an incentive for merchants to establish a sponsored location.

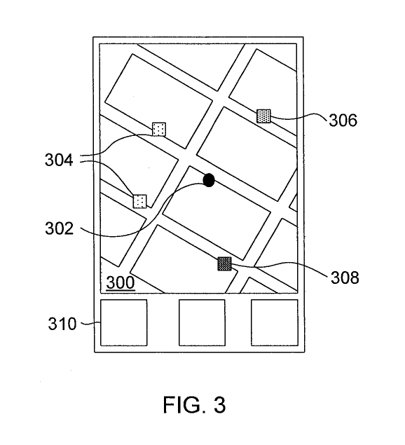

Referring now to FIG. 3, a map interface 300 is shown. The location of the device 100 is shown by black dot 302. Businesses 110 are shown as squares 304, 306, and 308 on the map interface 300. The squares represent icons that indicate business type and/or point value. A graphical indicator, such as color or brightness can be used to show the rating or point value of a given business 110. For example, squares 304 are shown as being lightly shaded, whereas square 306 has a darker shade, indicating a higher approval rate. Additionally, sponsored locations may be shown with separate icons 308. The user may tap on any such icon to access additional information and details regarding the promotions at the associated business 110.

The interface also includes buttons 310. These buttons 310 may be used to filter displayed locations and allow the user to navigate in the display. The buttons 310 may further be present in every interface screen to provide interface uniformity or may be adapted to only show functions relevant to the particular screen being displayed. The buttons 310 may also allow a user to “check in” at a given location, to register an approval or disapproval, to register a new location, etc. When registering a new location, the user provides information about the business 110 including, e.g., its name and address. The mobile device 100 may automatically locate the address based on, e.g., GPS information. The registration may also include sponsorship information, if the venue wishes to become a sponsored business.

Upon activating an icon 304, users may visit a location/venue page to see deal details and location specifics. In one embodiment, the page may include a large image of the venue, the venue's point value, details about deals associated with the venue, a phone number, an address, and buttons 310 including an “Add Sponsorship” button that links to an Upsell page, Thumbs Up/Down buttons (approval) and a Check In button. Additionally, the Location/Venue page may display deal details, days and hours of the deal, and user images of the venue. The bottom of the page can contain buttons 310 to activate certain other functionalities, such as Map, Friends, Search, Dashboard, and Rally Point.

When a user clicks a Check In button at a sponsored location, the user is shown a page that explains that, to earn points for the check in, the user will need to take a picture of the check with the amount spent visible. Alternative methods for providing verification information are also contemplated, including without limitation manual entry, transmission by the venue directly, or any other appropriate means for communicating to the server 108 that the transaction took place. This picture is sent back to the system operator providing the system operator with a verifiable transaction during the check in. Additionally other pictures taken during the visit can be awarded bonus points. While checking in users can leave comments about a location for friends and other users. In a preferred embodiment, all comments are private and only visible to those in a preselected group. If a user provides the required check in information, a Thank You message may be displayed that informs the user of how many points were earned for the check in. The user may also be invited to take additional pictures to earn bonuses and may be presented a button to take a picture. Preferably, locations are geolocated before any check-in, whether sponsored or not, will be credited to the user.

An Up-Sell Page may be used to solicit a business 110 to become a sponsored location. Preferably, the Up-Sell Page will display text or other data describing how the venue will benefit from becoming a sponsored location. In a preferred embodiment, the Up-Sell Page will include an interface displaying fields such as Contact Name, E-mail Address, and Phone Number through which the mobile software application can acquire information useful for contacting the venue at a subsequent time to inquire about establishing a sponsorship. The subsequent contact may include sending an e-mail to the e-mail address provided by the contact, which allows the contact to upload credit card information for the sponsorship in a secured environment.

The mobile software application may further include a Friends Page that will allow users to add friends to the application. Preferably, the user will be able to import friends from an e-mail address book or other contact list, or from social media applications such as Facebook® and Twitter®. The application may also include the functionality to apply tags to contacts to create different groups, e.g., college friends, local, family, etc. The application may also build a default “local group” that includes friends in the same geographic region as the user who added them.

A user can additionally build public groups and subscribe to existing public groups. The system operator could use the groups to notify a user's friends of a user's discoveries and check-ins via a phone notification (e.g., SMS message) or via a Facebook® alert. In one embodiment, a user can directly message any group or individual friend to alert him about a venue or meeting places (“Rally Points”). A group may further pool the award points of all its members and direct it to a shared cause (e.g., school fund raiser, charity walk, Motorcycle run). Preferably, a user will have the ability to block messages from non-friends or groups.

The interface may also include a Search Page that causes the mobile device to display options for searching Locations, Friends, and Groups. In one embodiment, the user may access the Search Page by activating a button on another page. From the Search Page, a user can search all categories or a subset for local venues. Optionally, users can also search subscribed groups for venues and events. For example, users could search for events for a college alumni group or sports team. Optionally, users can search for local hot spots, as indicated by the venues' system point values.

A dashboard/settings page allows users to see their status and settings and edit default settings. The Dashboard/Settings Page can include the user name, current points, dollars redeemed, number of check ins, number of check ins by category, level achieved last check in, last sponsored location, last sponsored location signed, and system broadcasts. In one embodiment, a user can activate a small button 310 in a corner to enter a mode that allows the user to edit certain fields and settings. The bottom of the Dashboard/Settings Page can contain buttons 310 to activate certain other functionalities, such as Map, Friends, Search, Dashboard, and Rally Point.

The Settings Page displays an interface through which a user can modify settings. For example, the user could be allowed to set an alerts radius which will determine how close a venue with an active offer must be to a user in order for the user to receive an alert of that offer. From the Settings Page, the user may also be able to add and subtract categories about which the system will display offers, create and curate groups, add searchable keywords to profile the user's profile, and enable or disable check in notices from Group Members.

A user may further set a “Rally Point” by using a button 310 on the interface or by choosing “Add Location” and choosing only the “Rally” category. This will launch the “Add Location” screen with “Rally” selected. A Rally Point is a temporary location entered by a user for an unsponsored location. Preferably, the Rally Point can be made public or private. In one embodiment, the Rally Point can be shared with a notification from one user to another. Some potential uses for Rally Points include formal or informal events, such as raves, house parties, or a meet up point for a group in an unfamiliar location, but the uses of Rally Points are not limited to these illustrative examples.

All businesses 110 that are considered sponsored locations may pay the operator of server 108 a bounty for all users' check ins. Sponsored locations may also receive an enhanced location page as described above. The system operator may charge the sponsored location a percentage of the bill. Every time a user of the mobile software application checks in to a location with a verified transaction a charge is billed using the credit card information that was obtained when the location was solicited for an up-sell. The splitting of the charge with the users of the mobile software application was described above. One benefit of this method of charging the sponsored locations is that it generates an ongoing revenue stream to the system operator as users continue to check in to sponsored locations. Another benefit is that it reduces a venue's resistance to registering for a sponsored location that an upfront fee may create. One of skill in the art would recognize, however, that the choice in billing arrangements is a function of business judgment and that an upfront fee or a hybrid of an upfront fee and ongoing percentage fee may be utilized without departing from the scope of the present principles.

An additional feature that may be included with the system is a Signup Page that allows managers of sponsored locations to edit credit card and billing info. While the Signup Page could be part of the mobile software application, it could also be a separate website accessible from any Internet connected device, even if it does not have the mobile software application installed.

Sponsored businesses 110 may have access to a Venue Dashboard that allows managers of sponsored locations to edit to the Venue Page associated with their sponsored location, update ads and offers as often as they want, create daily specials, add/change a menu link, add/change contact info, add/change phone, add/change pictures, etc. The Venue Dashboard may also allow owners of sponsored locations to check their account status, including metrics such as a number of check-ins by day or week, total bounty paid, credit left, and detailed reports on check-in by week/month/year.

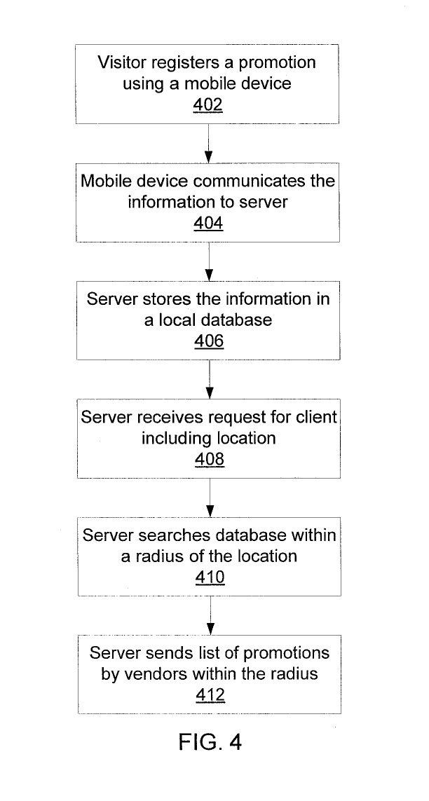

Referring now to FIG. 4, a method for crowd-sourced promotion is shown. At block 402 a user enters a location for a business 110, discovers a new promotion (e.g., a two-for-one sale) and registers the promotion using the mobile device 100. The mobile device 100 communicates this information to server 108 at block 404, storing the information in a local database at block 406. In this way, a database of sales and other promotions can be generated using solely the efforts of self-motivated individual users, rather than relying on adoption by particular vendors. Once 108 a server receives a request from a client including a set of parameters (e.g., current location, search radius, etc.) at block 408, the server 108 searches its database for vendors that have promotions within the radius. The server 108 sends a list of promotions that match the user's parameters back to mobile device 100 at block 412.

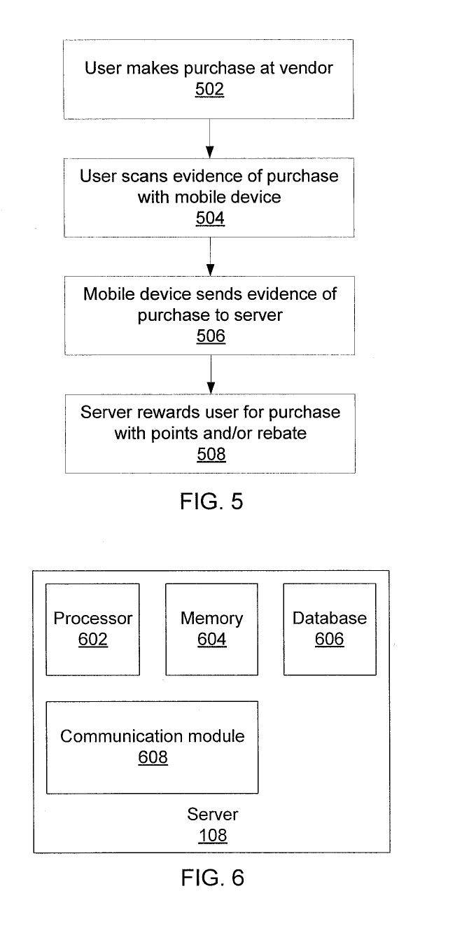

Referring now to FIG. 5, a method for incentivizing users is shown. Although incentives for exploration and registering new businesses 110 and promotions are shown above, users may also be incentivized to use the application to find promotions that have already been entered. In particular, when a user makes a purchase at a business 110 at block 502, the user may scan or enter some form of evidence of the transaction using mobile device 100 at block 504. The mobile device 100 then uploads the evidence of purchase to server 108 at block 506, which allows the server to confirm the validity of the purchase. At block 508, the server 108 rewards the user for the purchase using points and/or a rebate. For example, if the business 110 is a sponsored business, a portion of the fee paid by the business 110 may be given to the user as an instant rebate. If the business is not sponsored, the reward may be in the form of points or some other form of non-monetary recognition.

Referring now to FIG. 6, a detailed diagram of server 108 is shown. The server 108 includes a database 606 stored in a memory 604 that includes information regarding the registered promotions, users, and businesses 110. In addition to promotional information, the database stores scores for users and businesses 110. A processor 602 searches the database in response to requests received from, e.g., mobile device 100, at communication module 608. The communication module 608 may be any appropriate form of network communication device used to communicate with the mobile device 100, e.g., a wired or wireless network communication interface.

Having described preferred embodiments of a system and method for user-created business recommendations (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for providing promotional information, comprising:
collecting information at a server regarding promotions, including promotion location, supplied by a plurality of individual users;
receiving a request at the server from a requesting user that includes a user location;
searching the information at the server using a processor to generate a list of promotions within a radius of the user location; and
transmitting the list of promotions to the requesting user.

2. The method of claim 1, further comprising maintaining point scores at the server associated with each user and with one or more businesses.

3. The method of claim 2, further comprising receiving an indication of approval or disapproval from a reviewing user regarding a business.

4. The method of claim 3, further comprising increasing the point scores at the server associated with the reviewing user and the business upon receipt of an indication of approval.

5. The method of claim 3, further comprising decreasing the point score at the server associated with the business upon receipt of an indication of disapproval.

6. The method of claim 1, further comprising:
receiving a request from an upselling user to convert a business to a sponsored business; and
storing an entry at the server to represent a sponsored status for the business.

7. The method of claim 6, further comprising increasing the point score at the server associated with the upselling user.

8. The method of claim 6, further comprising collecting information at a server regarding promotions supplied by the sponsored business.

9. The method of claim 1, further comprising providing a rebate to a requesting user who uses a transmitted promotion.

10. The method of claim 9, wherein the rebate is redirected to a specified third party.

11. A system for providing promotional information, comprising:
a server configured to collect information regarding promotions supplied by a plurality of individual users, where said information includes a promotion location, and to receive a request from a requesting user that includes a user location, the server comprising:
a database configured to store the collected information;
a processor configured to search the database to generate a list of promotions within a radius of the user location; and
a communication module configured to transmit the list to of promotions to the requesting user.

12. The system of claim 11, wherein the database is further configured to maintain point scores at the server associated with each user and with one or more businesses.

13. The system of claim 12, wherein the server is further configured to receive an indication of approval or disapproval from a reviewing user regarding a business.

14. The system of claim 13, wherein the processor is further configured to increase the point scores in the database associated with the reviewing user and the business upon receipt of an indication of approval.

15. The system of claim 13, wherein the processor is further configured to decrease the point score at the server associated with the business upon receipt of an indication of disapproval.

16. The system of claim 11, wherein the server is further configured to receive a request from an upselling user to convert a business to a sponsored business and the database is further configured to store an entry to represent a sponsored status for the business.

17. The system of claim 16, wherein the processor is further configured to increase the point score at the server associated with the upselling user.

18. The system of claim 11, wherein the server is further configured to provide a rebate to a requesting user who uses a transmitted promotion.

19. The system of claim 18, wherein the rebate is redirected to a specified third party.

20. A non-transitory computer readable storage medium comprising a computer readable program for providing promotional information, wherein the computer readable program when executed on a computer causes the computer to perform the steps of:
collecting information at a server regarding promotions, including promotion location, supplied by a plurality of individual users;
receiving a request at the server from a requesting user that includes a user location;
searching the information at the server using a processor to generate a list of promotions within a radius of the user location; and
transmitting the list of promotions to the requesting user.
